(19) United States
(12) Patent Application Publication
(10) Pub. No.: US 2026/0221424 A1
(43) Pub. Date: Jul. 30, 2026

(54) POLYIMIDE-COATED CATHODE ACTIVE MATERIALS AND METHODS OF MANUFACTURING THE SAME

(71) Applicant: GM GLOBAL TECHNOLOGY OPERATIONS LLC, Detroit, MI (US)

(72) Inventors: Yun-Yu LAI, Clawson, MI (US); Raneen Taha, Sterling Heights, MI (US)

(21) Appl. No.: 19/038,308

(22) Filed: Jan. 27, 2025

(51) Int. Cl. H01M 4/36; H01M 4/02; H01M 4/04; H01M 4/131; H01M 4/1391; H01M 4/505; H01M 4/525; H01M 4/62

(52) U.S. Cl. CPC H01M 4/366; H01M 4/0471; H01M 4/131; H01M 4/1391; H01M 4/505; H01M 4/525; H01M 4/622; H01M 2004/021; H01M 2004/028

(57) ABSTRACT

A method of manufacturing a cathode electrode for a battery that cycles lithium ions includes contacting a cathode active material with a precursor solution including a polyamic acid in a polar solvent to form a reaction mixture, stirring the reaction mixture for a sufficient duration to deposit a precursor layer including the polyamic acid on surfaces of the cathode active material and form an intermediate product, separating the intermediate product from the polar solvent, and heating the intermediate product at a reaction temperature sufficient to initiate a thermal imidization reaction and transform the polyamic acid in the precursor layer to a polyimide layer on the surfaces of the cathode active material. The cathode active material includes a lithium and manganese-containing oxide having an upper cutoff potential of greater than or equal to 4.4 Volts versus Li⁺/Li.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to cathode active materials for batteries that cycle lithium ions.

Batteries that cycle lithium ions generally include a cathode electrode, an anode electrode spaced apart from the cathode electrode, and an ionically conductive electrolyte that provides a medium for the conduction of lithium ions between the cathode and anode electrodes during discharge and charge of the batteries. The electrochemically active materials in the electrodes are formulated such that, when the batteries are at least partially charged, an electrochemical potential difference is established between the cathode electrode and the anode electrode, which drives spontaneous reduction and oxidation (redox) reactions within the batteries and the generation of an electric current in an external circuit.

Batteries with high energy density may be desirable in certain applications because they can store and deliver a relatively large amount of energy in a relatively small or lightweight package. Efforts to increase the energy density of batteries may include increasing the specific capacity of the electrodes and/or increasing the cell output voltage, for example, by pairing a high-voltage cathode electrode with a low-voltage lithium metal or graphite anode electrode. When used as cathode active materials of batteries that cycle lithium ions, ithium-, nickel-, and manganese-containing oxides (NMX), such as layered Li(NiₓMn_{y})O₂, spinel Li(NiₓMn_{y})₂O₄, and layered lithium-rich Li_{1+z}(NiₓMn_{y})O₂ (x<0.8, y>0.2, and z≤0.33), may operate at voltages of greater than or equal to 4.5 V vs. Li/Li⁺ and thus may be considered desirable candidates for use as high-voltage cathode active materials. However, commercially available electrolytes may be unstable at such high voltages, which may result in undesirable side reactions between NMX cathode active materials and the electrolyte components. In practice, such side reactions may result in the dissolution of transition metal ions from the cathode active materials and associated structural changes, resulting in irreversible capacity loss and increased charge transfer resistance. To overcome these challenges, it may be desirable to prevent undesirable side reactions from occurring between high-voltage cathode active materials and the electrolytes of batteries that cycle lithium ions.

### SUMMARY

A method of manufacturing a cathode electrode for a battery that cycles lithium ions, in accordance with one or more embodiments of the disclosure, comprises contacting a cathode active material with a precursor solution comprising a polyamic acid in a polar solvent to form a reaction mixture, stirring the reaction mixture for a sufficient duration to deposit a precursor layer comprising the polyamic acid on surfaces of the cathode active material to form an intermediate product, separating the intermediate product from the polar solvent, and heating the intermediate product at a reaction temperature sufficient to initiate a thermal imidization reaction and transform the polyamic acid in the precursor layer to a polyimide layer on the surfaces of the cathode active material. The cathode active material comprises a lithium and manganese-containing oxide having an upper cutoff potential of greater than or equal to 4.4 Volts versus Li⁺/Li;

The cathode active material may comprise a layered lithium and manganese-containing transition metal oxide represented by the formula Li(Mn,Me)O₂, a layered lithium-rich manganese-containing transition metal oxide represented by the formula Li₁₊ₓ(Mn,Me)₁₋ₓO₂, where 0<x≤0.33, and/or a spinel-type lithium transition metal oxide represented by the formula Li(Mn, Me)₂O₄, where Me is at least one transition metal selected from the group consisting of Co, Ni, and Al. In aspects, the Me may be at least one transition metal selected from the group consisting of Ni and Al and the cathode active material may be substantially free of cobalt.

The polyamic acid may be a reaction product of an aromatic carboxylic dianhydride and an aromatic diamine. In such case, the aromatic carboxylic dianhydride may comprise pyromellitic dianhydride (PMDA); 3,3′,4,4′-benzophenonetetracarboxylic dianhydride; 3,4,9,10-perylenetetracarboxylic dianhydride; trimellitic anhydride chloride; trimellitic anhydride; tetrachlorophthalic anhydride; phthalic anhydride; naphthalene-1,4,5,8-tetracarboxylic dianhydride; or a combination thereof, and the aromatic diamine may comprise 4,4′-oxydianiline (ODA); bis(4-aminophenyl) sulfone; 4,4′-m-xylylenediamine; p-xylylenediamine; 4,4′-diaminodiphenyl ether; 4,4′-methylenebis(2,6-diethylaniline); 1,3-phenylenediamine; 4,4′-diaminodiphenylmethane; 4,4′-methylenebis(2-chloroaniline); α,α′-bis(4-aminophenyl)-1,4-diisopropylbenzene; or a combination thereof. In aspects, the aromatic carboxylic dianhydride may comprise pyromellitic dianhydride (PMDA) and the aromatic diamine may comprise 4,4′-oxydianiline (ODA).

The polar solvent may be at least one dipolar aprotic solvent selected from the group consisting of N,N-dimethylformamide (DMF), dimethyl sulfoxide (DMSO), N,N-dimethylacetamide (DMAc), or N-methylpyrrolidone (NMP).

The polyamic acid may comprise, by weight, greater than or equal to 0.5% and less than or equal to 2% of the precursor solution.

The cathode active material may be a particulate material. In such case, particles of the cathode active material may comprise, by weight, greater than or equal to 1% and less than or equal to 20% of the reaction mixture.

The intermediate product may be separated from the polar solvent by filtration or evaporation of the polar solvent.

The sufficient duration may be greater than or equal to 4 hours and less than or equal to 12 hours.

The intermediate product may be heated at the reaction temperature in an oxygen-containing environment.

The reaction temperature sufficient to initiate the thermal imidization reaction may be greater than or equal to 100 degrees Celsius and less than 350 degrees Celsius.

The intermediate product may be heated to initiate the thermal imidization reaction by: (i) heating the intermediate product at a first reaction temperature of greater than or equal to 100 degrees Celsius and less than 200 degrees Celsius for greater than or equal to 0.5 hours and less than or equal to 3 hours, and then (ii) heating the intermediate product at a second reaction temperature of greater than or equal to 200 degrees Celsius and less than 350 degrees Celsius for greater than or equal to 0.5 hours and less than or equal to 3 hours.

The polyimide layer may have a thickness of greater than or equal to 5 nanometers and less than or equal to 1 micrometer.

A battery that cycles lithium ions, in accordance with one or more embodiments of the disclosure, comprises a porous cathode electrode and an electrolyte infiltrating pores of the porous cathode electrode. The porous cathode electrode comprises a plurality of composite particles, with each of the composite particles having a core and an aromatic polymimide layer disposed on a surface of the core. The core of each of the composite particles comprises a lithium and manganese-containing cathode active material having an upper cutoff potential of greater than or equal to 4.4 Volts versus Li⁺/Li. The aromatic polymimide layer physically and electrically isolates the core from the electrolyte.

The aromatic polyimide layer may have a thickness of greater than or equal to 5 nanometers and less than or equal to 1 micrometer.

The aromatic polyimide layer may comprise the reaction product of an aromatic carboxylic dianhydride and an aromatic diamine. In such case, the aromatic carboxylic dianhydride may comprise pyromellitic dianhydride (PMDA); 3,3′,4,4′-benzophenonetetracarboxylic dianhydride; 3,4,9,10-perylenetetracarboxylic dianhydride; trimellitic anhydride chloride; trimellitic anhydride; tetrachlorophthalic anhydride; phthalic anhydride; naphthalene-1,4,5,8-tetracarboxylic dianhydride; or a combination thereof, and the aromatic diamine may comprise 4,4′-oxydianiline (ODA); bis(4-aminophenyl) sulfone; 4,4′-m-xylylenediamine; p-xylylenediamine; 4,4′-diaminodiphenyl ether; 4,4′-methylenebis(2,6-diethylaniline); 1,3-phenylenediamine; 4,4′-diaminodiphenylmethane; 4,4′-methylenebis(2-chloroaniline); α,α′-bis(4-aminophenyl)-1,4-diisopropylbenzene; or a combination thereof.

In aspects, the aromatic polyimide layer may comprise the reaction product of pyromellitic dianhydride (PMDA) and 4,4′-oxydianiline (ODA).

The core of each of the composite particles may have a diameter of greater than or equal to 1 micrometer and less than or equal to 40 micrometers.

The lithium and manganese-containing cathode active material may comprises a layered lithium and manganese-containing transition metal oxide represented by the formula Li(Mn, Me)O₂, a layered lithium-rich manganese-containing transition metal oxide represented by the formula Li₁₊ₓ(Mn,Me)₁₋ₓO₂, where 0<x≤0.33, and/or a spinel-type lithium transition metal oxide represented by the formula Li(Mn,Me)₂O₄, wherein Me is at least one transition metal selected from the group consisting of Co, Ni, and Al.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a cathode electrode, an anode electrode, a porous separator, and an electrolyte, wherein the cathode electrode comprises a plurality of composite particles comprising a core and a shell surrounding the core.

FIG. 4 is a schematic cross-sectional view of one of the composite particles of FIG. 3, wherein the core comprises a cathode active material (CAM) and the shell comprises a polyimide (PI).

FIG. 5 is a plot of Voltage (Volts) vs. Normalized Capacity (%) depicting charge and discharge curves for cells including a baseline positive electrode and cells including a positive electrode comprising PI-CAM composite particles.

FIG. 6 is a plot of Normalized Capacity Retention (%) vs. Cycle Number for cells including a baseline positive electrode and cells including a positive electrode comprising PI-CAM composite particles.

In the drawings, reference numbers may be reused to identify similar and/or identical elements.

### DETAILED DESCRIPTION

The presently disclosed cathode electrodes are formulated for use in batteries that cycle lithium ions to help prevent or inhibit undesirable side reactions from occurring between the cathode active materials and the electrolytes in the batteries, which may be particularly beneficial in batteries that include NMX cathode active materials and operate at relatively high voltages (e.g., >4.4 V versus Li⁺/Li). To prevent or inhibit such undesirable side reactions, the cathode active materials (CAM) particles in the presently disclosed cathode electrodes are encapsulated or at least partially surrounded by a polyimide (PI) layer. In the resulting PI-CAM composite particles, the PI layer is in the form of a substantially homogeneous, thin layer physically bonded to the surface of the CAM particles.

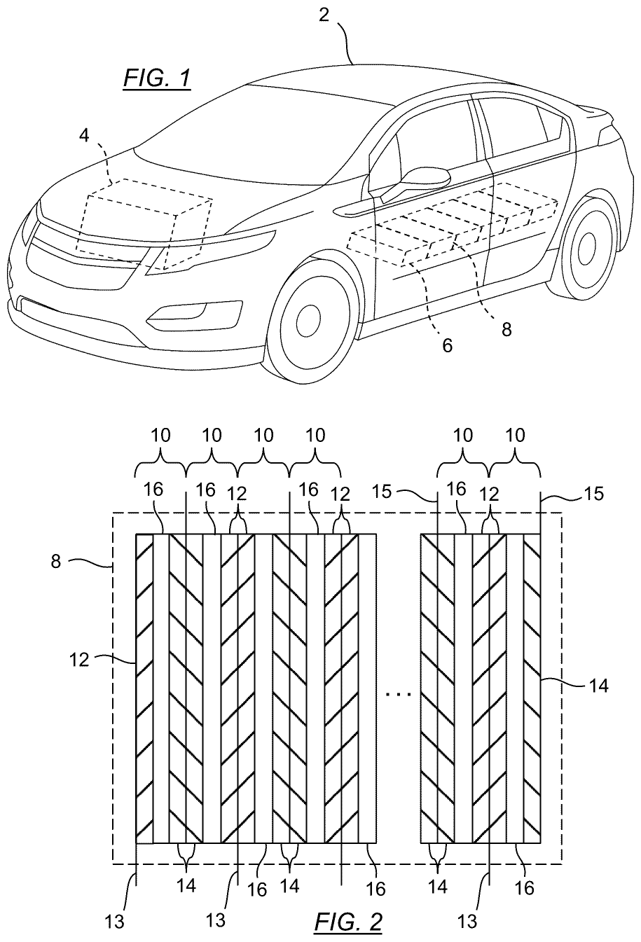

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including anode electrode layers 12, anode electrode current collectors 13, cathode electrode layers 14, cathode electrode current collectors 15, and separator layers 16. Each battery 10 is defined by an anode electrode layer 12 and a cathode electrode layer 14, which are spaced apart from each other by a separator layer 16. In practice, the separator layer 16 may be infiltrated with an electrolyte that provides a medium for the conduction of lithium ions between the anode electrode layer 12 and the cathode electrode layer 14, or the separator layer 16 itself may function as an electrolyte. The anode electrode layers 12 are disposed on and in electrical communication with the anode electrode current collectors 13 and the cathode electrode layers 14 are disposed on an in electrical communication with the cathode electrode current collectors 15. As shown in FIG. 2, for efficiency, the layers may be stacked such that some of the anode electrode current collectors 13 and some of the cathode electrode current collectors 15 are double sided and respectively include anode electrode layers 12 or cathode electrode layers 14 on both sides thereof. In this arrangement, adjacent anode electrode layers 12 share a single anode electrode current collector 13 and adjacent cathode electrode layers 14 share a single cathode current collector 15.

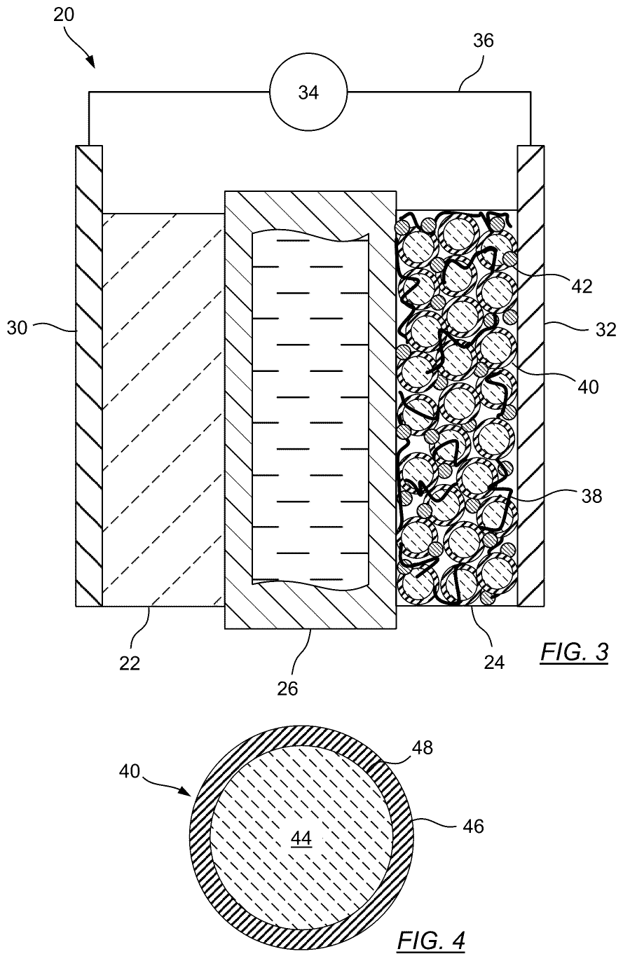

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. While the battery 20 is described herein in the contact of vehicles, the battery 20 can be used in other mobile and/or stationary applications.

The battery 20 comprises an anode electrode 22, a cathode electrode 24, a separator 26, and an electrolyte 28 that infiltrates the cathode electrode 24, the separator 26, and optionally the anode electrode 22. The anode electrode 22 is disposed on a major surface of an anode electrode current collector 30 and the cathode electrode 24 is disposed on a major surface of a cathode current collector 32. The separator 26 is electrochemically inactive and physically separates and electrically isolates the anode electrode 22 and the cathode electrode 24 from each other while permitting lithium ions to pass therethrough. The electrolyte 28 is ionically conductive, provides a medium for the conduction of lithium ions between the anode electrode 22 and the cathode electrode 24, and comprises a nonaqueous aprotic organic solvent (e.g., a mixture of linear carbonate and a cyclic carbonate) and a lithium salt (e.g., LiPF₆) in the organic solvent. In practice, the anode electrode current collector 30 and the cathode current collector 32 are made of an electrically conductive material (e.g., metal) and are electrically coupled to a power source or load 34 (e.g., the electric motor 4) via an external circuit 36.

The electrochemically active materials in the anode electrode 22 and the cathode electrode 24 are formulated such that, when the battery 20 is at least partially charged, an electrochemical potential difference is established between the anode electrode 22 and the cathode electrode 24. During discharge of the battery 20, the electrochemical potential established between the anode electrode 22 and the cathode electrode 24 drives spontaneous reduction and oxidation (redox) reactions within the battery 20 and the release of lithium ions and electrons from the anode electrode 22. The released lithium ions travel from the anode electrode 22 to the cathode electrode 24 through the separator 26 and the electrolyte 28, while the electrons travel from the anode electrode 22 to the cathode electrode 24 via the external circuit 36, which generates an electric current. After the anode electrode 22 has been partially or fully depleted of lithium, the battery 20 may be charged by connecting the anode electrode 22 and the cathode electrode 24 to the power source 34, which drives nonspontaneous redox reactions within the battery 20 and the release of the lithium ions and the electrons from the cathode electrode 24. The repeated discharge and charge of the battery 20 may be referred to herein as “cycling,” with a full charge event followed by a full discharge event being considered a full cycle.

As best shown in FIG. 3, the cathode electrode 24 is a composite material and includes a polymeric matrix component 38 and a particulate component embedded in the polymeric matrix component 38. The particulate component includes composite particles 40 and optionally electrically conductive particles 42 distributed throughout the polymeric matrix component 28. The cathode electrode 24 may be in the form of a continuous porous layer disposed on the major surface of the cathode current collector 32.

As best shown in FIG. 4, each of the composite particles 40 in the cathode electrode 24 has a core-shell structure defined by a core 44 and a polyimide layer 46 disposed on a surface 48 of the core 44. The core 44 of each of the composite particles 40 may comprise, by weight, greater than or equal to 95%, optionally greater than or equal to 99%, or optionally greater than or equal to 99.95%, and less than or equal to about 99.99% of the composite particle 40. The polyimide layer 46 of each of the composite particles 40 may comprise, by weight, greater than or equal to 0.01%, optionally greater than or equal to 0.05%, or optionally greater than or equal to 1%, and less than or equal to 5% of the composite particle 40.

The core 44 of each of the composite particles 40 comprises an electrochemically active cathode electrode material (cathode active material) formulated to store and release lithium ions during charge and discharge, respectively, of the battery 20. In aspects, the cathode active material in the core 44 of each of the composite particles 40 may be a “high-voltage” cathode active material having an upper cutoff potential of greater than or equal to 4.3 V, optionally greater than or equal to 4.4 V, or optionally greater than or equal to 4.5 V, and less than or equal to 5 V versus Li⁺/Li. The core 44 of each of the composite particles 40 may have a diameter of greater than or equal to 1 micrometer and less than or equal to 40 micrometers. The cathode active material in the core 44 of each of the composite particles 40 may comprise, by weight, greater than or equal to 70%, optionally greater than or equal to 80%, or optionally greater than or equal to 90% and less than or equal to 98%, optionally less than or equal to 95%, or optionally less than or equal to 90% of the cathode electrode 24.

The cathode active material comprises a lithium transition metal oxide that can store and release lithium ions by undergoing the reversible insertion or intercalation of lithium ions. For example, the cathode active material in the core 44 of the composite particles 40 may comprise a layered lithium and manganese-containing transition metal oxide represented by the formula Li(Mn, Me)O₂, a layered lithium-rich manganese-containing transition metal oxide represented by the formula Li₁₊ₓ(Mn,Me)₁₋ₓO₂ (where 0<x≤0.33), a spinel-type lithium and manganese-containing transition metal oxide represented by the formula Li(Mn, Me)₂O₄, or a combination thereof, where Me is a transition metal (e.g., Co, Ni, Fe, Al, V, or a combination thereof). In aspects, Me may comprise at least one transition metal selected from the group consisting of Co, Ni, and Al. In aspects, Me may comprise Ni. For example, in aspects, the cathode active material may comprise a layered lithium-rich manganese-based transition metal oxide (LMR) represented by the formula Li₁₊ₓMn_{y}Me_{1-y}O₂, where 0<x≤0.33 and 0.5<y<1, and where Me comprises Co, Ni, Fe, Al, and/or, V; optionally Co, Ni, and/or Al; or optionally Ni. Other examples of layered lithium and manganese-containing transition metal oxides represented by the above formulas include lithium nickel manganese oxide (NMO); lithium, nickel, cobalt, manganese oxide (NCM); and lithium, nickel, manganese, aluminum oxide (NCMA). In aspects, the cathode active material and/or the entire cathode electrode 24 may be substantially free of cobalt.

The polyimide layer 46 is electrochemically inactive, ionically conductive, and electrically insulating and is configured to prevent or inhibit undesirable chemical reactions from occurring between the electrolyte 28 and the cathode active material in the core 44 of the composite particles 40, without hindering the transport or diffusion of lithium ions therethrough. For example, the polyimide layer 46 may help prevent or inhibit undesirable chemical reactions from occurring between the electrolyte 28 and the cathode active material, which might otherwise lead to transition metal ion dissolution from the cathode active material. As such, the polyimide layer 46 may help maintain the physical structure of the cathode active material and thereby improve the cycle life of the battery 20. As shown in FIG. 4, the polyimide layer 46 may have a substantially homogenous thickness and may be disposed on the surface 48 of the core 44 in the form of a continuous layer that completely encapsulates the core 44. And, because the thickness of the polyimide layer 46 is substantially uniform, the polyimide layer 46 may help promote the uniform and effective transfer of lithium ions between the electrolyte 28 and the cathode active material, which may help improve the electrochemical performance of the battery 20. In aspects, the polyimide layer 46 may have a thickness of greater than or equal to 1 nanometer (nm), optionally greater than or equal to 5 nm, and less than or equal to 1 micrometer (μm), optionally less than or equal to 100 nm, or optionally less than or equal to 10 nm.

The polymeric matrix component 38 is electrochemically inactive and may be included in the cathode electrode 24 to provide the cathode electrode 24 with structural integrity and/or to help the cathode electrode 24 adhere to the major surface of the cathode current collector 32. The polymeric matrix component 38 comprises a polymer binder. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the cathode electrode 24.

The optional electrically conductive particles 42 are electrochemically inactive and may be included in the cathode electrode 24 to provide the cathode electrode 24 with sufficient electrical conductivity to support the percolation of electrons therethrough. The optional electrically conductive particles 42 comprise an electrically conductive material, which may be a carbon-based material, metal (e.g., nickel), and/or electrically conductive polymer. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the cathode electrode 24, the optional electrically conductive particles 42 may constitute, by weight, greater than 0%, optionally greater than or equal to about 1%, or optionally greater than or equal to about 5% and less than or equal to about 10% of the cathode electrode 24.

### Methods

The composite particles 40 may be manufactured by contacting cathode active material particles with a precursor solution to form a reaction mixture. The cathode active material particles may be made of the same material as the cathode active material in the core 44 of the composite particles 40 and may have substantially the same dimensions. The precursor solution may comprise a polyamic acid in a polar solvent. The polyamic acid may comprise the reaction product of an aromatic carboxylic dianhydride and an aromatic diamine. Examples of aromatic carboxylic dianhydrides include pyromellitic dianhydride (PMDA); 3,3′,4,4′-benzophenonetetracarboxylic dianhydride; 3,4,9,10-perylenetetracarboxylic dianhydride; trimellitic anhydride chloride; trimellitic anhydride; tetrachlorophthalic anhydride; phthalic anhydride; and naphthalene-1,4,5,8-tetracarboxylic dianhydride. Examples of aromatic diamines include 4,4′-oxydianiline (ODA); bis(4-aminophenyl) sulfone; 4,4′-m-xylylenediamine; p-xylylenediamine; 4,4′-diaminodiphenyl ether; 4,4′-methylenebis(2,6-diethylaniline); 1,3-phenylenediamine; 4,4′-diaminodiphenylmethane; 4,4′-methylenebis(2-chloroaniline); and α,α′-bis(4-aminophenyl)-1,4-diisopropylbenzene. In aspects, the polyamic acid may comprise the reaction product of pyromellitic dianhydride (PMDA) and 4,4′-oxydianiline (ODA). In such case, the polyamic acid may comprise poly(pyromellitic dianhydride-co-4,4′-oxydianiline), amic acid.

The polar solvent may comprise a dipolar aprotic solvent. Examples of dipolar aprotic solvents include N,N-dimethylformamide (DMF), dimethyl sulfoxide (DMSO), N,N-dimethylacetamide (DMAc), and/or N-methylpyrrolidone (NMP). In aspects, the polar solvent may comprise NMP.

The concentration of the polyamic acid in the precursor solution may be selected to produce a polyimide layer 26 having a desired thickness on surfaces of the cathode active material particles. In aspects, the polyamic acid may comprise, by weight, greater than or equal to 0.1%, or optionally greater than or equal to 0.5%, and less than or equal to 5%, or optionally less than or equal to 2% of the precursor solution.

The concentration of the cathode active material particles in the reaction mixture may be selected to ensure thorough and homogeneous deposition of the polyamic acid on the surfaces of the cathode active material particles. In aspects, the cathode active material particles may comprise, by weight, greater than or equal to 1%, optionally greater than or equal to 2%, or optionally greater than or equal to 5%, and less than or equal to 20%, or optionally less than or equal to 10% of the reaction mixture.

The reaction mixture is stirred for a sufficient duration to deposit a precursor layer comprising the polyamic acid on surfaces of the cathode active material particles, thereby forming an intermediate product. For example, the reaction mixture may be stirred for greater than or equal to 4 hours, or optionally greater than or equal to 6 hours, and less than or equal to 12 hours, or optionally less than or equal to 10 hours. In aspects, the reaction mixture may be stirred for about 8 hours.

After deposition of the precursor layer on the surfaces of the cathode active material particles, the intermediate product is physically separated from the precursor solution, which may comprise the polar solvent and any residual polyamic acid remaining in the polar solvent and not deposited on the cathode active material particles. The intermediate product may be physically separated from the precursor solution, for example, by filtration or by evaporating the polar solvent from the reaction mixture.

After the intermediate product is physically separated from the precursor solution, the composite particles 40 are formed by heating the intermediate product at a reaction temperature sufficient to initiate a thermal imidization reaction and transform the polyamic acid in the precursor layer to the polyimide layer 46 on the surfaces of the cathode active material (i.e., on the core 44). To initiate a thermal imidization reaction and transform the polyamic acid in the precursor layer to the polyimide layer 46, the intermediate product may be heated at a reaction temperature of greater than or equal to 100 degrees Celsius (° C.) and less than 350° C. In aspects, the intermediate product may be heated in a two-stage process. In such case, initiation of the thermal imidization reaction may be accomplished by heating the intermediate product at a first reaction temperature of greater than or equal to 100° C. and less than 200° C. for greater than or equal to 0.5 hours and less than or equal to 3 hours, and then heating the intermediate product at a second reaction temperature of greater than or equal to 200° C. and less than 350° C. for greater than or equal to 0.5 hours and less than or equal to 3 hours. The intermediate product may be heated in an oxygen-containing environment, e.g., in air.

The cathode electrode 24 may be manufactured by mixing the composite particles 40 with a polymer binder, optionally an electrically conductive material, and a solvent to form a slurry, depositing the slurry on a substrate, and then removing the solvent therefrom.

### Experimental

Example composite particles 40 were prepared using solution deposition and thermal imidization techniques. As starting materials, cathode active material particles (CAM) having a layered crystal structure and comprising a lithium nickel manganese oxide represented by the formula LiNi_{0.75}Mn_{0.25}O₂ were used. The CAM particles were dispersed in polyamic acid-containing precursor solutions to form reaction mixtures. The precursor solutions comprised, by weight, either 0.5% poly(pyromellitic dianhydride-co-4,4′-oxydianiline), amic acid (PAA) or 2% PAA in NMP. The CAM particles were added to the precursor solutions in an amount such that the CAM particles constituted, by weight, about 5% of the reaction mixtures. Thereafter, the reaction mixtures were mixed vigorously for 8 hours to ensure thorough and homogeneous deposition of PAA on the surfaces of the CAM particles. Then, the PAA-coated CAM particles were separated from the precursor solutions by filtration. The PAA-coated CAM particles were heated in air at a temperature of 150° C. for 1 hour, followed by heating at a temperature of 300° C. for 1 hour to initiate a thermal imidization reaction and transform the PAA in the PAA-coated CAM particles to a polyimide, thereby forming PI-coated CAM composite particles, i.e., composite particles 40.

The thickness of the PI coatings on the PI-CAM composite particles was measured using a transmission electron microscope (TEM). The PI coatings formed on the PI-CAM composite particles prepared using the 0.5% PAA precursor solution had thicknesses in the range of 1 nm to 5 nm. The PI coatings formed on the PI-CAM composite particles prepared using the 2% PAA precursor solution had thicknesses in the range of 5 nm to 10 nm.

Positive electrodes according to embodiments of the present disclosure were prepared by mixing the as-prepared PI-CAM composite particles with a polymer binder, an electrically conductive material, and a solvent to form a slurry, depositing the slurry on a substrate, and then removing the solvent therefrom. For comparison, baseline positive electrodes were prepared in the same manner using uncoated CAM particles (instead of PI-CAM composite particles).

Full coin cells including the as-prepared positive electrodes were assembled and evaluated using galvanostatic charge and discharge protocols. All cells included an anode electrode comprising graphite and an electrolyte comprising 1 Molar LiPF₆ in a solvent mixture comprising ethylene carbonate (EC) and ethyl methyl carbonate (EMC) (EC:EMC=3:7 vol/vol) and 2 wt. % vinylene carbonate (VC). The cells were galvanostatically charged and discharged using a C/3 charge rate to 4.4 V and a C/3 discharge rate to 2.5 V.

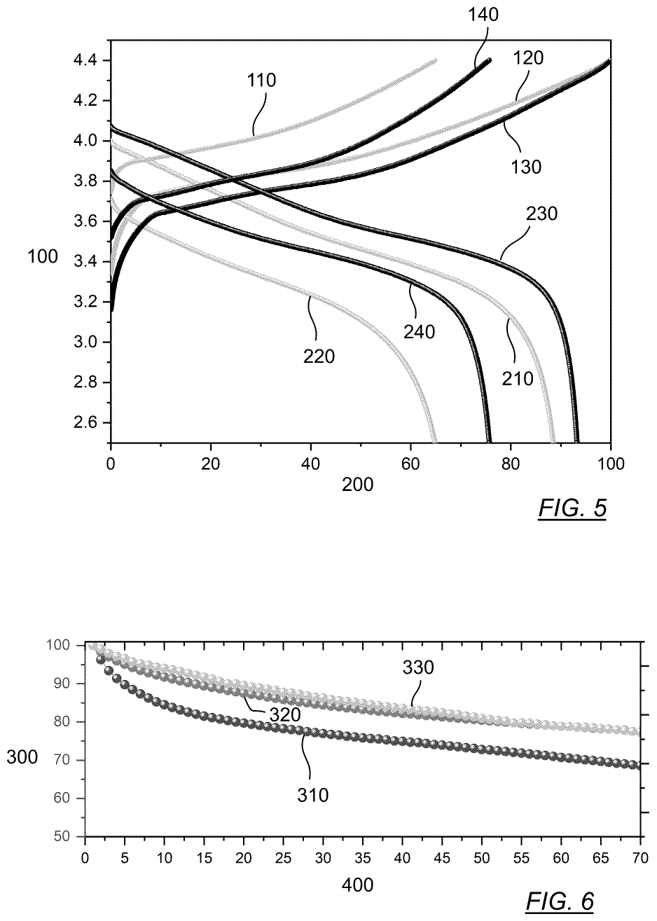

FIG. 5 is a plot of Voltage (Volts) 100 vs. Normalized Capacity (%) 200 depicting charge and discharge curves for cells including the baseline positive electrode and cells including a positive electrode comprising the as-prepared PI-CAM composite particles. Curves 110 and 210 respectively depict the charge and discharge curves for a cell including the baseline positive electrode after the 1^{st} cycle, and curves 120 and 220 respectively depict the charge and discharge curves for the a cell including the baseline positive electrode after the 45^{th} cycle. Curves 130 and 230 respectively depict the charge and discharge curves after the 1^{st} cycle and curves 140 and 240 respectively depict the charge and discharge curves after the 45^{th} cycle for a cell including a positive electrode comprising PI-CAM composite particles prepared using the 0.5% PAA precursor solution (0.5% PI-CAM-positive electrode). As shown in FIG. 5, after the 45^{th} cycle, the discharge voltage of the cell including the baseline positive electrode decreased by about 0.278 V, while the discharge voltage of the cell including the 0.5% PI-CAM-positive electrode only decreased by 0.218 V, about a 20% improvement.

FIG. 6 is a plot of Normalized Capacity Retention (%) 300 vs. Cycle Number 400 for a cell including the baseline positive electrode 310, a cell including a positive electrode comprising PI-CAM composite particles prepared using the 0.5% PAA precursor solution (0.5% PI-CAM-positive electrode) 320, and a cell including a positive electrode comprising PI-CAM composite particles prepared using the 2% PAA precursor solution (2% PI-CAM-positive electrode) 330. As shown in FIG. 6, cells with positive electrodes including the PI-CAM composite particles had significantly improved capacity retention, as compared to cells including the baseline positive electrode.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A method of manufacturing a cathode electrode for a battery that cycles lithium ions, the method comprising:
contacting a cathode active material with a precursor solution comprising a polyamic acid in a polar solvent to form a reaction mixture, the cathode active material comprising a lithium and manganese-containing oxide having an upper cutoff potential of greater than or equal to 4.4 Volts versus Li⁺/Li;
stirring the reaction mixture for a sufficient duration to deposit a precursor layer comprising the polyamic acid on surfaces of the cathode active material to form an intermediate product;
separating the intermediate product from the polar solvent; and
heating the intermediate product at a reaction temperature sufficient to initiate a thermal imidization reaction and transform the polyamic acid in the precursor layer to a polyimide layer on the surfaces of the cathode active material.

2. The method of claim 1, wherein the cathode active material comprises:
a layered lithium and manganese-containing transition metal oxide represented by the formula Li(Mn,Me)O₂;
a layered lithium-rich manganese-containing transition metal oxide represented by the formula Li₁₊ₓ(Mn,Me)₁₋ₓO₂, where 0<x≤0.33; and/or
a spinel-type lithium transition metal oxide represented by the formula Li(Mn,Me)₂O₄,
wherein Me is at least one transition metal selected from the group consisting of Co, Ni, and Al.

3. The method of claim 2, wherein Me is at least one transition metal selected from the group consisting of Ni and Al, and wherein the cathode active material is substantially free of cobalt.

4. The method of claim 1, wherein the polyamic acid is a reaction product of an aromatic carboxylic dianhydride and an aromatic diamine.

5. The method of claim 4, wherein the aromatic carboxylic dianhydride comprises pyromellitic dianhydride (PMDA); 3,3′,4,4′-benzophenonetetracarboxylic dianhydride; 3,4,9,10-perylenetetracarboxylic dianhydride; trimellitic anhydride chloride; trimellitic anhydride; tetrachlorophthalic anhydride; phthalic anhydride; naphthalene-1,4,5,8-tetracarboxylic dianhydride; or a combination thereof, and wherein the aromatic diamine comprises 4,4′-oxydianiline (ODA); bis(4-aminophenyl) sulfone; 4,4′-m-xylylenediamine; p-xylylenediamine; 4,4′-diaminodiphenyl ether; 4,4′-methylenebis(2,6-diethylaniline); 1,3-phenylenediamine; 4,4′-diaminodiphenylmethane; 4,4′-methylenebis(2-chloroaniline); α,α′-bis(4-aminophenyl)-1,4-diisopropylbenzene; or a combination thereof.

6. The method of claim 4, wherein the aromatic carboxylic dianhydride comprises pyromellitic dianhydride (PMDA) and the aromatic diamine comprises 4,4′-oxydianiline (ODA).

7. The method of claim 1, wherein the polar solvent comprises at least one dipolar aprotic solvent selected from the group consisting of N,N-dimethylformamide (DMF), dimethyl sulfoxide (DMSO), N,N-dimethylacetamide (DMAc), or N-methylpyrrolidone (NMP).

8. The method of claim 1, wherein the polyamic acid comprises, by weight, greater than or equal to 0.5% and less than or equal to 2% of the precursor solution.

9. The method of claim 1, wherein the cathode active material is a particulate material, and wherein particles of the cathode active material comprise, by weight, greater than or equal to 1% and less than or equal to 20% of the reaction mixture.

10. The method of claim 1, wherein the intermediate product is separated from the polar solvent by filtration or evaporation of the polar solvent.

11. The method of claim 1, wherein the sufficient duration is greater than or equal to 4 hours and less than or equal to 12 hours.

12. The method of claim 1, wherein the intermediate product is heated at the reaction temperature in an oxygen-containing environment, and wherein the reaction temperature sufficient to initiate the thermal imidization reaction is greater than or equal to 100 degrees Celsius and less than 350 degrees Celsius.

13. The method of claim 1, wherein the intermediate product is heated to initiate the thermal imidization reaction by:
heating the intermediate product at a first reaction temperature of greater than or equal to 100 degrees Celsius and less than 200 degrees Celsius for greater than or equal to 0.5 hours and less than or equal to 3 hours; and then
heating the intermediate product at a second reaction temperature of greater than or equal to 200 degrees Celsius and less than 350 degrees Celsius for greater than or equal to 0.5 hours and less than or equal to 3 hours.

14. The method of claim 1, wherein the polyimide layer has a thickness of greater than or equal to 5 nanometers and less than or equal to 1 micrometer.

15. A battery that cycles lithium ions, the battery comprising:
a porous cathode electrode comprising a plurality of composite particles, with each of the composite particles having a core and an aromatic polymimide layer disposed on a surface of the core, the core of each of the composite particles comprising a lithium and manganese-containing cathode active material having an upper cutoff potential of greater than or equal to 4.4 Volts versus Li⁺/Li; and
an electrolyte infiltrating pores of the porous cathode electrode,
wherein the aromatic polymimide layer physically and electrically isolates the core from the electrolyte.

16. The battery of claim 15, wherein the aromatic polyimide layer has a thickness of greater than or equal to 5 nanometers and less than or equal to 1 micrometer.

17. The battery of claim 15, wherein the aromatic polyimide layer comprises the reaction product of an aromatic carboxylic dianhydride and an aromatic diamine, wherein the aromatic carboxylic dianhydride comprises pyromellitic dianhydride (PMDA); 3,3′,4,4′-benzophenonetetracarboxylic dianhydride; 3,4,9,10-perylenetetracarboxylic dianhydride; trimellitic anhydride chloride; trimellitic anhydride; tetrachlorophthalic anhydride; phthalic anhydride; naphthalene-1,4,5,8-tetracarboxylic dianhydride; or a combination thereof, and wherein the aromatic diamine comprises 4,4′-oxydianiline (ODA); bis(4-aminophenyl) sulfone; 4,4′-m-xylylenediamine; p-xylylenediamine; 4,4′-diaminodiphenyl ether; 4,4′-methylenebis(2,6-diethylaniline); 1,3-phenylenediamine; 4,4′-diaminodiphenylmethane; 4,4′-methylenebis(2-chloroaniline); α,α′-bis(4-aminophenyl)-1,4-diisopropylbenzene; or a combination thereof.

18. The battery of claim 15, wherein the aromatic polyimide layer comprises the reaction product of pyromellitic dianhydride (PMDA) and 4,4′-oxydianiline (ODA).

19. The battery of claim 15, wherein the core of each of the composite particles has a diameter of greater than or equal to 1 micrometer and less than or equal to 40 micrometers.

20. The battery of claim 15, wherein the lithium and manganese-containing cathode active material comprises:
a layered lithium and manganese-containing transition metal oxide represented by the formula Li(Mn, Me)O₂;
a layered lithium-rich manganese-containing transition metal oxide represented by the formula Li₁₊ₓ(Mn,Me)₁₋ₓO₂, where 0<x≤0.33; and/or
a spinel-type lithium transition metal oxide represented by the formula Li(Mn,Me)₂O₄,
wherein Me is at least one transition metal selected from the group consisting of Co, Ni, and Al.
